(19) United States
(12) Patent Application Publication
(10) Pub. No.: US 2019/0156372 A1
(43) Pub. Date: May 23, 2019

(54) ELECTRONIC SYSTEM AND METHOD FOR ADVERTISEMENT PRICING

(71) Applicant: MASTERCARD INTERNATIONAL INCORPORATED, PURCHASE, NY (US)

(72) Inventors: Ajay Nehra, Gurgaon (IN); Deepak Yadav, Gurgaon (IN); Shreya Mittal, New Delhi (IN)

(21) Appl. No.: 16/193,593

(22) Filed: Nov. 16, 2018

(30) Foreign Application Priority Data
Nov. 17, 2017 (SG) 10201709510Q

(51) Int. Cl. G06Q 30/02

(52) U.S. Cl. CPC G06Q 30/0273; G06Q 30/0265

(57) ABSTRACT

The present disclosure generally relates to an electronic system, a computerized method, and a non-transitory computer-readable storage medium for advertisement pricing. The system comprises a host server configured for performing steps of the method comprising: identifying a locality for displaying an advertisement; receiving traffic observation data from one or more traffic servers; generating vehicular traffic data based on the traffic observation data, the vehicular traffic data indicative of vehicular traffic activity in the locality; and performing an advertisement pricing process based on at least the vehicular traffic data to determine advertisement prices for displaying the advertisement in the locality.

### CROSS-REFERENCE TO RELATED APPLICATION

This application claims the benefit of and priority to Singapore Patent Application No. 10201709510Q, filed Nov. 17, 2017. The entire disclosure of the above application is incorporated herein by reference.

### FIELD

The present disclosure generally relates to an electronic system and method for advertisement pricing. Particularly, the present disclosure describes various embodiments of an electronic system and method for determining advertisement prices based on at least vehicular traffic data.

### BACKGROUND

This section provides background information related to the present disclosure which is not necessarily prior art.

Advertisements may be defined or used as a form of marketing communication for promoting or selling merchandise, such as goods, products, services, and other activities. Merchants and businesses often rely on various advertising channels to attract customers to purchase their merchandise. Some of these advertising channels include displaying visual advertisements at various locations in a geographical area or locality, such as a city or town. Some examples of these advertisements include visual advertisements on digital screens, banners, posters, hoardings, and billboards. For example, advertisements may be displayed as billboards along arterial roads and highways servicing the locality. These roads tend to have high vehicular traffic activity, resulting in better chances of gaining more advertisement impressions.

Conventionally, advertisements are charged to merchants based on a fixed price rate, such as $1,000 per day. In some cases, the fixed price rate is dependent on the locality where the advertisement is displayed and possibly the size of the advertisement. For example, the fixed price rate may be higher if the advertisement is positioned at a locality, e.g. business district, serviced by major roads where there is potentially higher vehicular traffic activity. However, the business district is likely to have relatively higher vehicular traffic activity during weekday morning and evening peak hours, and relatively lower vehicular traffic activity at other hours and weekends. Merchants have to pay the fixed price rate for the entire day but there is high vehicular traffic activity only during limited hours of the day, which will result in the merchants finding that their money spent is not worthwhile.

Therefore, in order to address or alleviate at least one of the aforementioned problems and/or disadvantages, there is a need to provide an electronic system and method for advertisement pricing.

### SUMMARY

This section provides a general summary of the disclosure, and is not a comprehensive disclosure of its full scope or all of its features. Aspects and embodiments of the disclosure are set out in the accompanying claims.

According to an aspect of the present disclosure, there is an electronic system, a computerized method, and a non-transitory computer-readable storage medium for advertisement pricing. The system comprises a host server configured for performing steps of the method comprising: identifying a locality for displaying an advertisement; receiving traffic observation data from one or more traffic servers; generating vehicular traffic data based on the traffic observation data, the vehicular traffic data indicative of vehicular traffic activity in the locality; and performing an advertisement pricing process based on at least the vehicular traffic data to determine advertisement prices for displaying the advertisement in the locality.

An electronic system and method for advertisement pricing according to the present disclosure is thus disclosed herein. Various features, aspects, and advantages of the present disclosure will become more apparent from the following detailed description of the embodiments of the present disclosure, by way of non-limiting examples only, along with the accompanying drawings.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is an illustration of an electronic system for advertisement pricing, in accordance with embodiments of the present disclosure.

FIG. 2 is a flowchart illustration of a computerized method for advertisement pricing, in accordance with embodiments of the present disclosure.

FIG. 3 is an illustration of various tables (including Table 1A and Table 1B) of the advertisement pricing, in accordance with embodiments of the present disclosure.

FIG. 4 is an illustration of an electronic system for advertisement pricing, in accordance with other embodiments of the present disclosure.

FIG. 5 to FIG. 7 are illustrations of various tables (including Tables 2-4) of the advertisement pricing, in accordance with other embodiments of the present disclosure.

FIG. 8 is a block diagram illustration of the technical architecture of a host server of the electronic system, in accordance with embodiments of the present disclosure.

Corresponding reference numerals indicate corresponding parts throughout the several views of the drawings.

### DETAILED DESCRIPTION

Embodiments of the present disclosure will be described, by way of example only, with reference to the drawings. The description and specific examples included herein are intended for purposes of illustration only and are not intended to limit the scope of the present disclosure.

In the present disclosure, depiction of a given element or consideration or use of a particular element number in a particular figure or a reference thereto in corresponding descriptive material can encompass the same, an equivalent, or an analogous element or element number identified in another figure or descriptive material associated therewith. The use of “/” in a figure or associated text is understood to mean “and/or” unless otherwise indicated. For purposes of brevity and clarity, descriptions of embodiments of the present disclosure are directed to an electronic system and method for advertisement pricing, in accordance with the drawings. While aspects of the present disclosure will be described in conjunction with the embodiments provided herein, it will be understood that they are not intended to limit the present disclosure to these embodiments. On the contrary, the present disclosure is intended to cover alternatives, modifications and equivalents to the embodiments described herein, which are included within the scope of the present disclosure as defined by the appended claims. Furthermore, in the following detailed description, specific details are set forth in order to provide a thorough understanding of the present disclosure. However, it will be recognized by an individual having ordinary skill in the art, i.e., a skilled person, that the present disclosure may be practiced without specific details, and/or with multiple details arising from combinations of aspects of particular embodiments. In a number of instances, known systems, methods, procedures, and components have not been described in detail so as to not unnecessarily obscure aspects of the embodiments of the present disclosure.

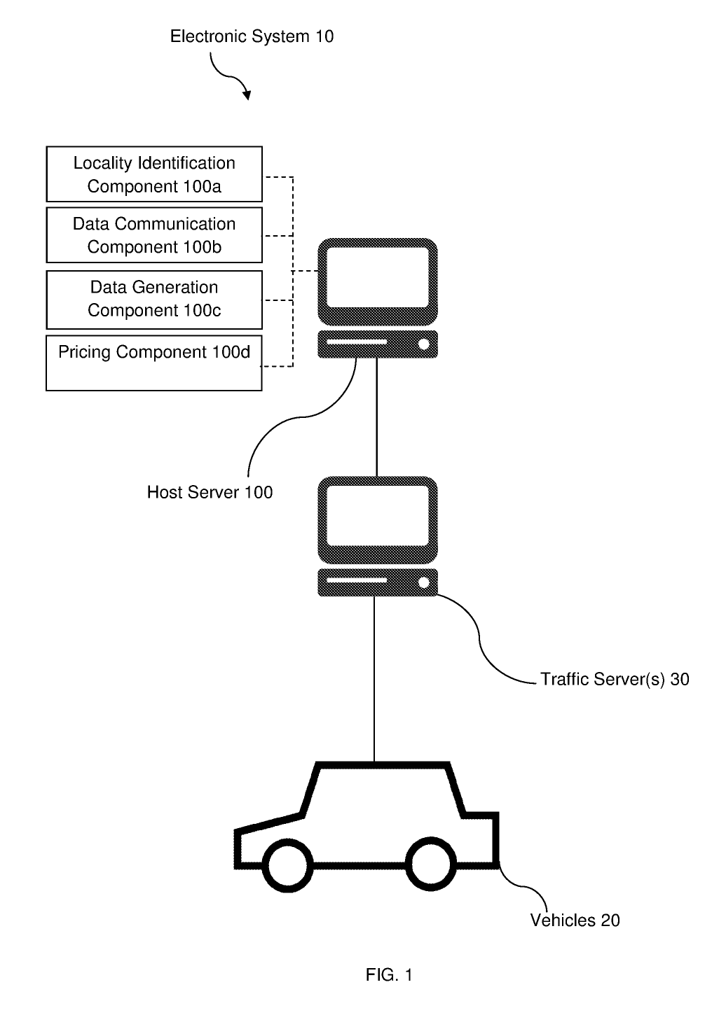

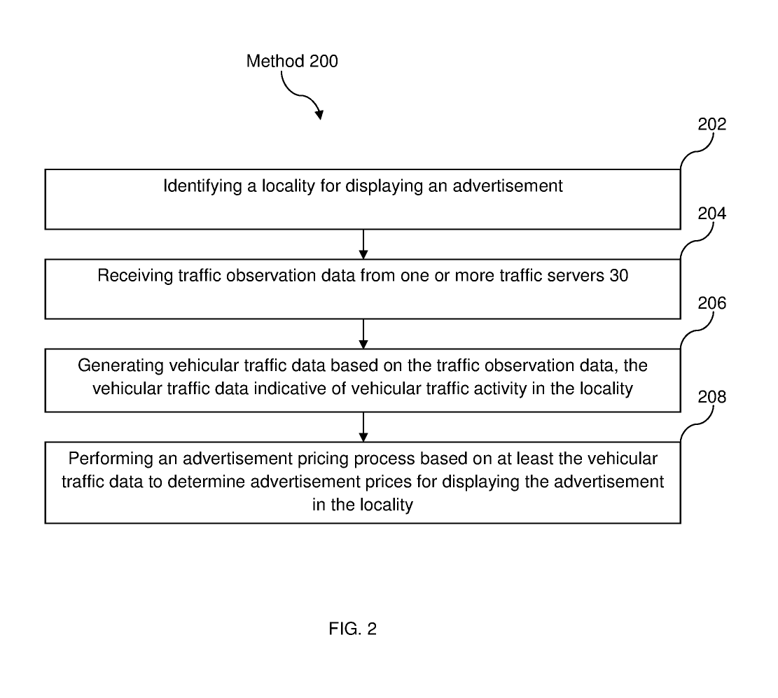

In representative or exemplary embodiments of the present disclosure, there is provided an electronic system 10 for advertisement pricing as illustrated in a schematic diagram in FIG. 1. The system 10 includes a host server 100 having a processor and a data storage device or memory configured to store computer-readable instructions for performing various steps of a method 200 for advertisement pricing, as illustrated in FIG. 2. The host server 100 may be operated by a commercial entity, such as an advertisement business entity or a financial entity, e.g., Mastercard® or Visa®.

In a step 202 of the method 200, a locality identification component/module 100a of the host server 100 identifies a locality for displaying an advertisement. The locality refers to a portion, region, or subset of a wider geographical region or area. The geographical region may span broadly across a city or an entire country. The locality may thus refer to a town, district, or a local area of the city or country. Particularly, the locality is serviced by a number of streets, roads, and/or highways where vehicles 20 uses to pass through the locality, contributing to vehicular traffic activity in the locality which in turn leads to more impressions of the displayed advertisement. The locality may be identified based on an electronic or digital map provided by a map service provider, such as Google Maps or Apple Maps. The locality may be identified based on postal code regions with predefined boundaries. Alternatively, the locality may be demarcated by boundaries in the geographical region, such as latitude and longitude coordinates and boundaries.

The system 10 further includes one or more traffic servers 30 communicatively linked to the host server 100. The traffic servers 30 provide traffic observation data of the vehicles 20 in the locality, wherein the traffic observation data may include, for example, traffic camera data and road toll data. The traffic servers 30 may be operated by government or official agencies that provide such traffic observation data. Alternatively or additionally, the traffic servers 30 may be operated by private entities that can observe traffic in the locality and provide relevant traffic observation data.

In a step 204, a data communication component/module 100b of the host server 100 receives traffic observation data from the one or more traffic servers 30. In one example, the traffic observation data includes traffic camera data of the vehicles 20 obtained from a number of camera devices located within the locality and/or wherein the locality is within visual range of the camera devices. The camera devices provide an overview of the locality and the number of vehicles 20 passing through the locality can be determined from the traffic camera data. In another example, the traffic observation data includes road toll data. Whenever a vehicle 20 passes through a road toll gantry in the locality, the road toll charge may be automatically deducted from a payment instrument coupled to a wireless electronic device, e.g., an RFID device, in the vehicle 20. The number of vehicles 20 passing through the road toll gantries in the locality can be determined based on the road toll data.

In a step 206, a data generation component/module 100c of the host server 100 generates vehicular traffic data based on the traffic observation data of the vehicles 20. The vehicular traffic data is indicative or representative of vehicular traffic activity in the locality. Information such as vehicular traffic density in the locality, and the number and rate of the vehicles 20 passing through the locality may be determined based on the vehicular traffic data. For example, the vehicle traffic data may determine a traffic density of a certain number of vehicles 20 passing through the locality over a predefined period, e.g., 100 vehicles per minute over the period 1 pm to 2 pm. This translates to an average of 6,000 vehicles in the locality from 1 pm to 2 pm. Assuming that the advertisement to be displayed is within visual of the vehicles 20, i.e., people inside the vehicles 20 are able to see the advertisement, and each vehicle 20 generates an average of two impressions, there would be an average of 12,000 impressions of the advertisement from 1 pm to 2 pm.

In a step 208, a pricing component/module 100d of the host server 100 performs an advertisement pricing process based on at least the vehicular traffic data to determine advertisement prices for displaying the advertisement in the locality. The vehicular traffic data is thus useful to estimate the level of vehicular traffic activity in the locality, which is in turn used to determine the advertisement prices. As the vehicular traffic activity in one locality is usually different from another locality, the advertisement prices tend to vary between different localities. For example, a locality with higher vehicular traffic activity (determined from the vehicular traffic data) will have higher advertisement prices as compared to another locality with lower vehicular traffic activity. Based on the varying advertisement prices and the vehicular traffic activities affecting the advertisement prices, merchants can assess which localities are more suitable to place advertisements to advertise their merchandise, knowing that the advertisement prices they are paying are correlated with the level of vehicular traffic activity.

The advertisement pricing process includes determining the advertisement prices for each of a plurality of periods. For example, the plurality of periods may comprise six 4-hour time blocks spanning a 24-hour day. It will be appreciated that the periods may be shorter, e.g., hourly or bi-hourly, or longer, e.g., in 6-hour or 8-hour time blocks. In one embodiment, the advertisement prices are determined for each of six 4-hour periods spanning a 24-hour day, i.e., 12 am to 4 am, 4 am to 8 am, 8am to 12 pm, 12 pm to 4 pm, 4 pm to 8 pm, and 8 pm to 12 am.

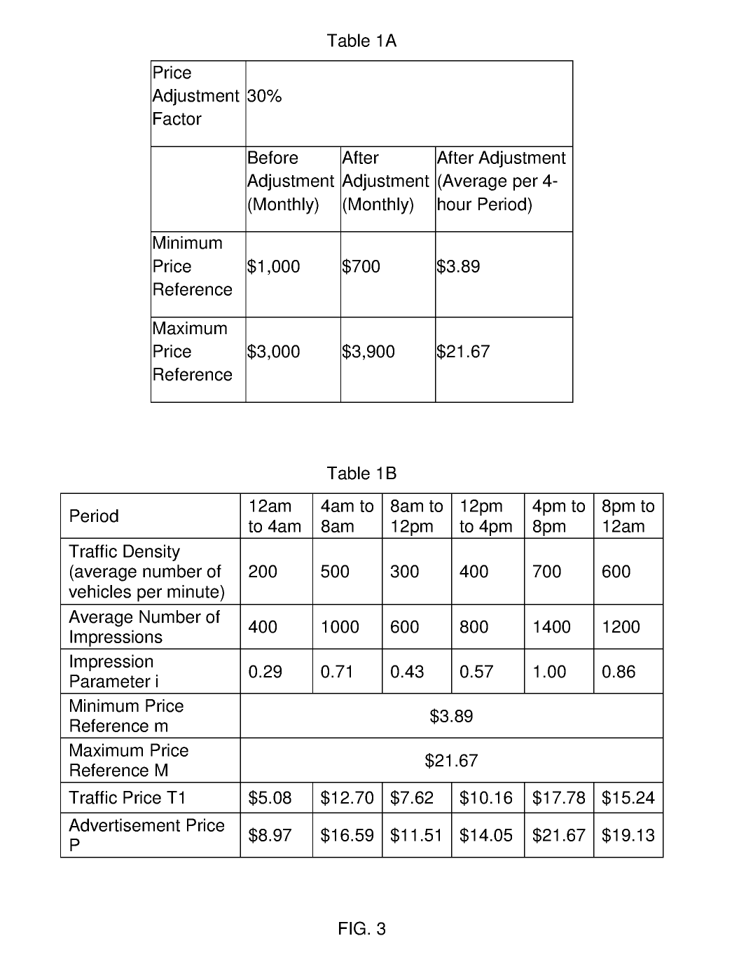

The advertisement pricing process includes determining the advertisement prices based on predefined advertisement price references. The predefined advertisement price references serve as an initial benchmark for determining the advertisement prices. For example, the predefined advertisement price references may include existing minimum and maximum advertisement price (fixed price rates) for the locality, such as the minimum and maximum price rates for displaying an advertisement billboard. The minimum and maximum price rates are determined from historical averages of the price rates. In one embodiment, the predefined advertisement price references include a minimum price reference of $1,000 per month and a maximum price reference of $3,000 per month. A price adjustment factor, e.g., 30%, may be applied to the minimum and maximum price references to widen the reference price range, such as to account for/provide a buffer for unexpected price fluctuations. The minimum and maximum price references are then converted from a monthly rate to an average for each period, e.g., a 4-hour time block. Table 1A in FIG. 3 tabulates the price references accordingly.

The advertisement pricing process further includes determining various parameters to derive the advertisement prices for each period, wherein one or more parameters are determined based on at least the vehicular traffic data of the locality. For example, the traffic density or average number of vehicles 20 passing through the locality per minute is determined from the vehicular traffic data for each period.

The advertisement pricing process includes determining an impression parameter for each period based on the vehicular traffic data. The impression parameter is associated with the average number of impressions which an advertisement displayed in the locality can gain. In one embodiment, the impression parameter is determined from a predefined average number of impressions per vehicle 20, e.g., two impressions per vehicle 20 regardless of the type of vehicle 20. In another embodiment, the impression parameter is determined based on vehicle types. Particularly, the average number of impressions per vehicle 20 varies among the types of vehicles 20. For example, larger vehicles 20 such as buses and coaches are likely to have a higher average number of impressions while smaller vehicles 20 such as cars and motorcycles having smaller average number of impressions. For simplicity, each vehicle 20 is expected to provide two impressions on average. The impression parameter may be determined as a proportion of the number of impressions in each period over the highest number of impressions among all periods.

The advertisement prices for each period can be determined from the impression parameters and price references. One example of a pricing formula is shown in Equations 1 and 2 below and further with reference to Table 1B in FIG. 3. T1 denotes an intermediate parameter referred to as a traffic price, P denotes the advertisement price, i denotes the impression parameter, m denotes the minimum price reference, and M denotes the maximum price reference.

T1=i×(M−m) (1)

P=m+T1 (2)

Various algorithms may be applied to the impression parameters and/or pricing references to modify or adjust the equations, e.g., by normalizing or weighting, and determine the advertisement prices as will be readily understood by the skilled person. The algorithms may also be trained and refined with continued collection and analysis of more vehicular traffic data, thereby improving the reliability of the advertisement pricing process.

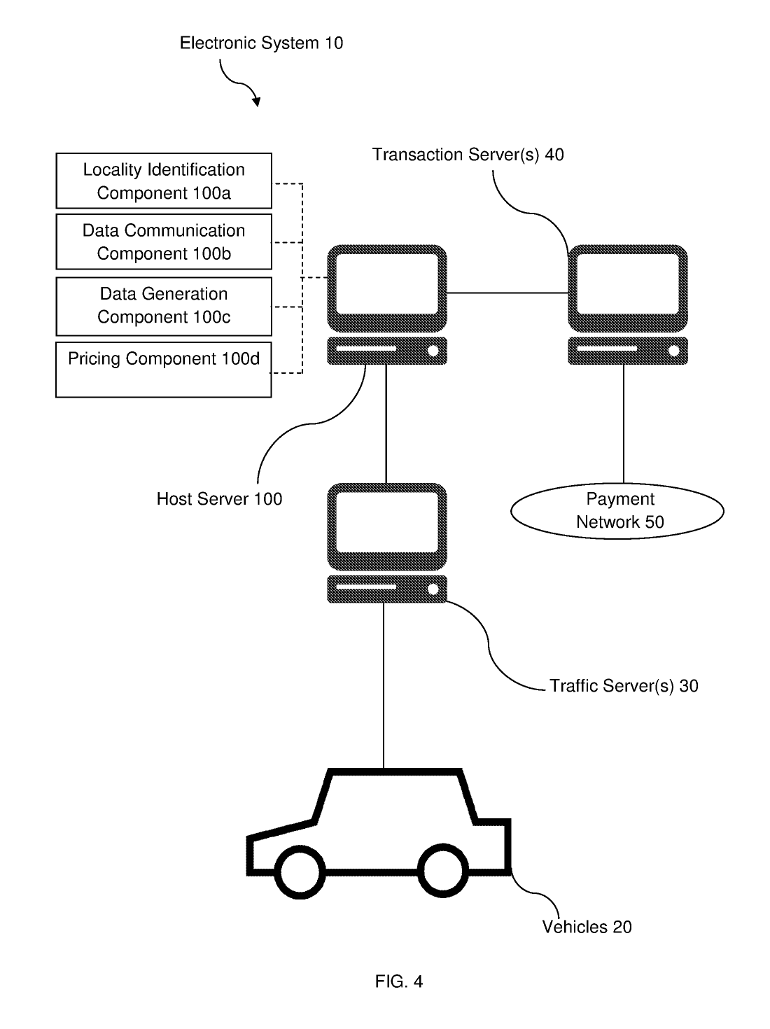

In some embodiments with reference to FIG. 4, the system 10 further includes one or more transaction servers 40 communicatively linked to the host server 100. The transaction servers 40 provide local transaction data that is generated from merchant transactions between merchants and consumers that occur in or around the locality. The system 10 further includes a payment network 50 for processing the merchant transactions. The transaction servers 40 and/or payment network 50 may be operated by a financial entity such as Mastercard® or Visa®.

In a typical merchant transaction between a merchant and a consumer, the local transaction data is communicated from a merchant point-of-sale (POS) terminal/billing machine to the transaction servers 40 and payment network 50 for processing of the merchant transaction. The local transaction data includes, among other things, identification data of the merchant and expenditure data of the merchant transaction (i.e., transaction cost or amount). In the locality, there is a number of merchants operating, such as in the form of retail stores. The locations of the merchants/retail stores may be represented by their location addresses and/or latitude/longitude coordinates, so as to determine whether the merchants are located within or around the locality.

Additionally, the merchant identification data may include or be used to identify the merchant category or industry of the merchant. Some merchant categories or codes include GRO (groceries), EAP (eating places), and BWL (beer, wine & liquor). Some merchant industries include everyday spend industry, travel and entertainment industry, and consumer packaged goods industry. The merchants in each of the locality can thus be identified, and the transaction data associated with merchant transactions in the locality can be determined. For example, in the locality, there is a number of merchant transactions that has occurred over a predefined historical period, e.g., 6 months or 1 year. For each merchant transaction, there is local transaction data associated therewith and the local transaction data includes the merchant identification data, expenditure data, and optionally the merchant category.

In some embodiments, the method 200 further comprises receiving, by the host server 100 and from the one or more other transaction servers 40, local transaction data associated with merchant transactions in the locality. The host server 100 performs the advertisement pricing process based additionally on the local transaction data.

In some embodiments, the advertisement pricing process includes determining a transaction frequency parameter for each period based on the local transaction data. The transaction frequency parameter is associated with an average number of merchant transactions that occurred in the respective periods. A higher number of merchant transactions is indicative of higher consumer traffic activity. The transaction frequency parameter may be useful to merchants who wish to know the periods when there is higher consumer traffic activity so as to maximize exposure of their advertisements.

The transaction frequency parameter may be determined by the transaction servers 40 recording the number of merchant transactions based on the time stamps of the merchant transactions. The transaction frequency parameter may be determined as a proportion of the number of merchant transactions in each period over the highest number of merchant transactions among all periods.

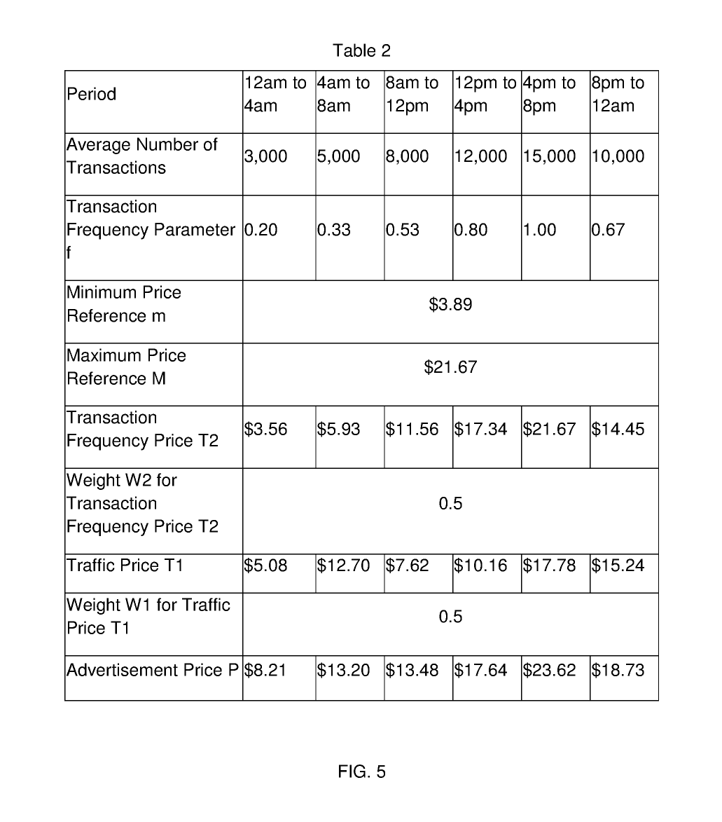

The advertisement pricing process further includes determining the advertisement prices based on the transaction frequency parameters in addition to the impression parameters and predefined advertisement price references. Accordingly, the advertisement prices are dependent on the impression parameters and transaction frequency parameters. One example of a pricing formula is shown in Equations 3 and 4 below and further with reference to Table 2 in FIG. 5. T2 denotes an intermediate parameter referred to as a transaction frequency price, and f denotes the transaction frequency parameter. For simplicity, the same traffic prices T1 from Table 1B are used in Table 2. Weights W1 and W2 may be applied to each of the traffic prices and transaction frequency prices, respectively, depending on their level of significance, wherein the weights sum up to one.

T2=f×(M−m) (3)

P=m+W1×T1+W2×T2 (4)

Similarly, various algorithms may be applied to modify or adjust the equations and determine the advertisement prices, as will be readily understood by the skilled person. The algorithms may also be trained and refined with continued collection and analysis of more vehicular traffic data and local transaction data, thereby improving the reliability of the advertisement pricing process.

In some embodiments, the advertisement pricing process includes determining an affluence parameter based on the local transaction data. The affluence parameter is associated with an average proportion of affluent consumers in the locality. The affluence parameter may be useful to merchants, especially those selling luxury goods, to assess whether the locality has a sufficient proportion of affluent consumers that may attract the merchants to display advertisements of their luxury goods.

The affluence parameter may be determined by identifying the affluent consumers based on the local transaction data and spending patterns of the affluent consumers. In a typical merchant transaction, a consumer may use a cashless payment instrument, e.g., credit card, to pay for the merchant transaction. Accordingly, consumers may be identified based on details of the payment instruments in the local transaction data, and the spending patterns of the consumers can then be determined. The spending patterns of the consumers may be determined based on global transaction data associated with global transactions performed by the consumers. Notably, the global transaction data is associated with merchant transactions that occur within and outside of the locality. The global transaction data thus provides a broad perspective of the spending patterns of each consumer identified from the local transaction data. Generally, if a consumer tends to purchase luxury goods and/or spends an expenditure amount above a predefined threshold over predefined period, the consumer is regarded as an affluent consumer. For simplicity, the affluence parameter is determined as 0.2, i.e., around 20% of the consumers in the locality are affluent consumers.

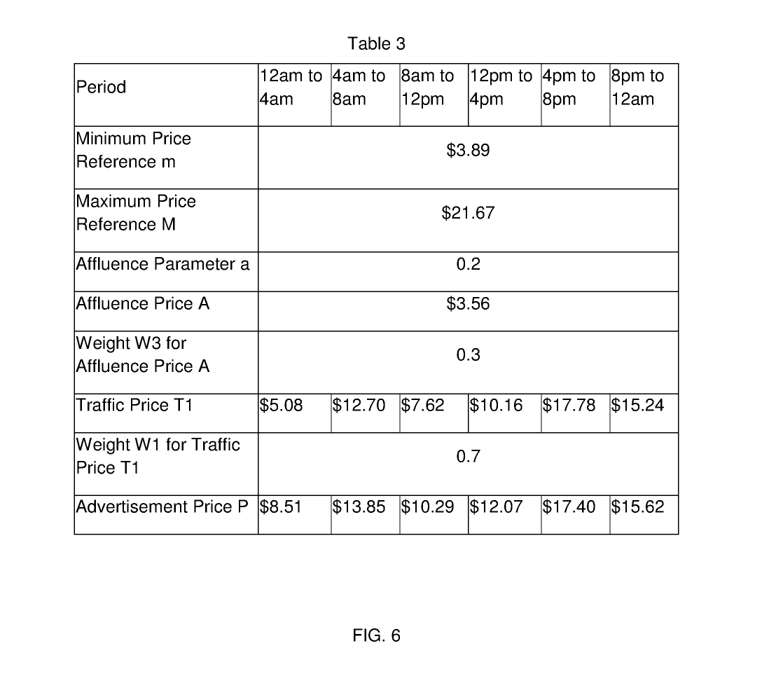

The advertisement pricing process further includes determining the advertisement prices based on the affluence parameter in addition to the impression parameters and predefined advertisement price references. Accordingly, the advertisement prices are dependent on the impression parameters and affluence parameter. One example of a pricing formula is shown in Equations 5 and 6 below and further with reference to Table 3 in FIG. 6. A denotes an intermediate parameter referred to as an affluence price, and a denotes the affluence parameter. For simplicity, the same traffic prices T1 from Table 1B are used in Table 3. Weights W1 and W3 may be applied to each of the traffic prices and affluence price, respectively, depending on their level of significance, wherein the weights sum up to one.

A=W3×a×(M−m) (5)

P=m+W1×T1+W3×A (6)

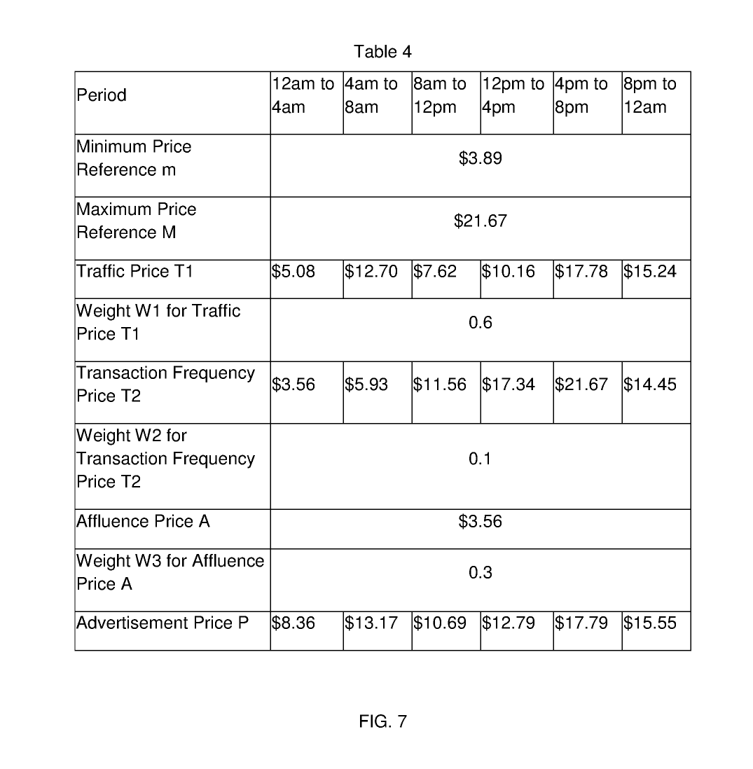

In some embodiments, the advertisement pricing process includes determining the transaction frequency parameters and affluence parameter based on the local transaction data. The advertisement pricing process further includes determining the advertisement prices based on the transaction frequency parameters and affluence parameter in addition to the impression parameters and predefined advertisement price references. Accordingly, the advertisement prices are dependent on the impression parameters, transaction frequency parameters, and affluence parameter. One example of a pricing formula is shown in Equation 7 below and further with reference to Table 4 in FIG. 7.

P=m+W1×T1+W2×T2+W3×A (7)

It will be appreciated that various algorithms may be applied to modify or adjust the equations and determine the advertisement prices, as will be readily understood by the skilled person. The algorithms may also be trained and refined with continued collection and analysis of more vehicular traffic data and local transaction data, thereby improving the reliability of the advertisement pricing process.

As described above, the advertisement prices vary according to the different periods due to varying vehicular traffic activity in the locality. This allows advertisement agencies to charge merchants according to the periods when their advertisements are displayed. Moreover, advertisement agencies may avail the periods for different merchants to select the appropriate periods to display their advertisements. For example, on a digital screen, a first advertisement from a first merchant may be displayed during a first period, and a second advertisement from a second merchant may be displayed during a second period. Merchants may select the periods based on the respective advertisement prices as well as the vehicular traffic activity which relates to viewership of their advertisements.

In some embodiments, the advertisement pricing process may determine the advertisement prices according to the merchant categories or industries, i.e., the advertisement prices may be separated/distinct by the merchant categories or industries determined from the local transaction data. By differentiating the advertisement prices in this manner, merchants from different industries do not have to pay the same advertisement prices for displaying advertisements at the same locality. For example, a merchant industry such as groceries/sundries pay lower advertisement prices than another merchant industry such as jewellery and branded goods, due to differences in the overall spending amounts of the merchant industries. Additionally, an advertisement category may be identified based on the local transaction data. This advertisement category may relate to the most popular merchant category, suggesting a propensity for consumers to make purchases in this merchant category. Displaying advertisements of this advertisement category potentially increases exposure and yield of the advertisements.

In some embodiments, the advertisement pricing process is performed continuously to determine real-time advertisement prices. Advertisement agencies can thus charge merchants more accurately according to the real-time advertisement prices. In some other embodiments, the advertisement pricing process is iteratively performed at predefined intervals, enabling the advertisement pricing process to generate updated advertisement prices. Advertisement agencies can thus update their advertisement prices and charge merchants accordingly. In one embodiment, the predefined intervals are further apart, such as monthly, quarterly, or annually. This allows for accumulation of more vehicular traffic data and local transaction data to improve and refine the advertisement pricing process. In another embodiment, the iterations are performed more frequently, such as hourly or daily, enabling the advertisement pricing process to generate almost real-time advertisement prices so that merchants can be more accurately charged for displaying their advertisements.

In some embodiments, the host server 100 receives service traffic data from one or more service providers. The service traffic data may be collated/aggregated with the traffic observation data to generate more accurate vehicular traffic data indicative of vehicular traffic activity in the locality. The service providers include, but are not limited to, one or more map service providers, such as Google Maps and Apple Maps, and/or one or more transportation service providers, such as Uber, Grab, and Lyft. It will be appreciated that there may be other types of service providers that would be able to generate useful service traffic data.

As described in the above embodiments, the vehicular traffic data is used to determine advertisement prices. The vehicular traffic data is indicative of vehicular traffic activity in the locality and may be used as an indicator of impressions generated by the advertisements displayed in the locality. The advertisement prices are dynamically adjustable according to various periods of differing vehicular traffic activity. For example, periods with higher vehicular traffic activity have higher advertisement prices. This addresses inefficiencies in the current fixed price rate arrangement which does not take into account the impressions generated.

Additionally, the local transaction data of the locality can be used to identify consumer mix which can help the advertisers to generate customized advertising campaigns for merchants for the locality and consumer preference instead of a generic advertisement which may not be relevant for the locality. The local transaction data can also be used to track the effectiveness of the advertisements. For example, an increase in expenditure amounts from the start to the end of an advertising campaign indicates higher revenue for the merchant and that the advertising campaign is successful. From the vehicular traffic data and local transaction data, merchants can estimate the impressions generated by the advertisements and also determine the type of consumers to target. This will help them to track the impact of an advertising campaign and measure their return on investment. It will also result in cost savings for the merchants as they are paying proportionally to the impressions generated by their advertisements.

### Technical Architecture

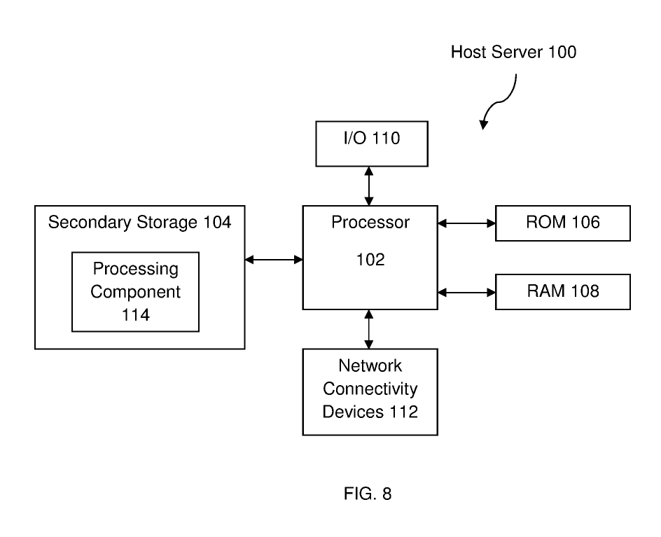

The following is a description of the technical architecture of a server, such as the host server 100, with reference to FIG. 8. It will be appreciated that the traffic server 30 and transaction server 40 may have similar technical architectures as well.

The technical architecture of the host server 100 includes a processor 102 (also referred to as a central processor unit or CPU) that is in communication with memory devices including secondary storage 104 (such as disk drives or memory cards), read only memory (ROM) 106, and random access memory (RAM) 108. The processor 102 may be implemented as one or more CPU chips. Various modules or components for performing various operations or steps of the method 200 are configured as part of the processor 102 and such operations or steps are performed in response to non-transitory instructions operative or executed by the processor 102.

The technical architecture further includes input/output (I/O) devices 110, and network connectivity devices 112. The secondary storage 104 typically includes a memory card or other storage device and is used for non-volatile storage of data and as an over-flow data storage device if RAM 108 is not large enough to hold all working data. Secondary storage 104 may be used to store programs which are loaded into RAM 108 when such programs are selected for execution.

The secondary storage 104 has a processing component 114, including non-transitory instructions operative by the processor 102 to perform various operations or steps of the method 200 according to various embodiments of the present disclosure. The ROM 106 is used to store instructions and perhaps data which are read during program execution. The secondary storage 104, the ROM 106, and/or the RAM 108 may be referred to in some contexts as computer-readable storage media and/or non-transitory computer-readable media. Non-transitory computer-readable media include all computer-readable media, with the sole exception being a transitory propagating signal per se.

The I/O devices 110 may include printers, video monitors, liquid crystal displays (LCDs), plasma displays, touch screen displays, keyboards, keypads, switches, dials, mice, track balls, voice recognizers, card readers, paper tape readers, and/or other known input devices.

The network connectivity devices 112 may take the form of modems, modem banks, Ethernet cards, universal serial bus (USB) interface cards, serial interfaces, token ring cards, fibre distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communication (NFC), radio frequency identity (RFID), and/or other air interface protocol radio transceiver cards, and other known network devices. These network connectivity devices 112 may enable the processor 102 to communicate with the Internet or one or more intranets. With such a network connection, it is contemplated that the processor 102 might receive information from the network, or might output information to the network in the course of performing the operations or steps of the method 200. Such information, which is often represented as a sequence of instructions to be executed using processor 102, may be received from and outputted to the network, for example, in the form of a computer data signal embodied in a carrier wave.

The processor 102 executes instructions, codes, computer programs, scripts which it accesses from hard disk, floppy disk, optical disk (these various disk based systems may all be considered secondary storage 104), flash drive, ROM 106, RAM 108, or the network connectivity devices 112. While only one processor 102 is shown, multiple processors may be present. Thus, while instructions may be discussed as executed by a processor, the instructions may be executed simultaneously, serially, or otherwise executed by one or multiple processors.

It will be appreciated that the technical architecture of the host server 100 may be formed by one computer, or multiple computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the multiple computers. In an embodiment, virtualization software may be employed by the technical architecture to provide the functionality of a number of servers that is not directly bound to the number of computers in the technical architecture. In an embodiment, the functionality disclosed above may be provided by executing the application and/or applications in a cloud computing environment. Cloud computing may include providing computing services via a network connection using dynamically scalable computing resources. A cloud computing environment may be established by an enterprise and/or may be hired on an as-needed basis from a third party provider.

It is understood that by programming and/or loading executable instructions onto the technical architecture of the host server 100, at least one of the CPU 102, the ROM 106, and the RAM 108 are changed, transforming the technical architecture in part into a specific purpose machine or apparatus having the functionality as taught by various embodiments of the present disclosure. It is fundamental to the electrical engineering and software engineering arts that functionality that can be implemented by loading executable software into a computer can be converted to a hardware implementation by known design rules.

In the foregoing detailed description, embodiments of the present disclosure in relation to an electronic system and method for advertisement pricing are described with reference to the provided figures. The description of the various embodiments herein is not intended to call out or be limited only to specific or particular representations of the present disclosure, but merely to illustrate non-limiting examples of the present disclosure. The present disclosure serves to address at least one of the mentioned problems and issues associated with the prior art. Although only some embodiments of the present disclosure are disclosed herein, it will be apparent to a person having ordinary skill in the art in view of this disclosure that a variety of changes and/or modifications can be made to the disclosed embodiments without departing from the scope of the present disclosure. Therefore, the scope of the disclosure as well as the scope of the following claims is not limited to embodiments described herein.

With that said, and as described, it should be appreciated that one or more aspects of the present disclosure transform a general-purpose computing device into a special-purpose computing device (or computer) when configured to perform the functions, methods, and/or processes described herein. In connection therewith, in various embodiments, computer-executable instructions (or code) may be stored in memory of such computing device for execution by a processor to cause the processor to perform one or more of the functions, methods, and/or processes described herein, such that the memory is a physical, tangible, and non-transitory computer readable storage media. Such instructions often improve the efficiencies and/or performance of the processor that is performing one or more of the various operations herein. It should be appreciated that the memory may include a variety of different memories, each implemented in one or more of the operations or processes described herein. What's more, a computing device as used herein may include a single computing device or multiple computing devices.

In addition, the terminology used herein is for the purpose of describing particular exemplary embodiments only and is not intended to be limiting. As used herein, the singular forms “a,” “an,” and “the” may be intended to include the plural forms as well, unless the context clearly indicates otherwise. And, again, the terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” and the term “at least one of” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

It is also noted that none of the elements recited in the claims herein are intended to be a means-plus-function element within the meaning of 35 U.S.C. § 112(f) unless an element is expressly recited using the phrase “means for,” or in the case of a method claim using the phrases “operation for” or “step for.”

Again, the foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computerized method for advertisement pricing, the method comprising:
identifying, by a host server, a locality for displaying an advertisement;
receiving, by the host server, traffic observation data from one or more traffic servers;
generating, by the host server, vehicular traffic data based on the traffic observation data, the vehicular traffic data indicative of vehicular traffic activity in the locality; and
performing, by the host server, an advertisement pricing process based on at least the vehicular traffic data to determine advertisement prices for displaying the advertisement in the locality.

2. The method according to claim 1, wherein performing the advertisement pricing process includes determining the advertisement prices for each of a plurality of periods.

3. The method according to claim 2, wherein performing the advertisement pricing process further includes determining an impression parameter for each period based on the vehicular traffic data.

4. The method according to claim 3, wherein the impression parameter is determined based on vehicle types.

5. The method according to claim 3, wherein performing the advertisement pricing process further includes determining the advertisement prices based on at least the impression parameters and predefined advertisement price references.

6. The method according to claim 5, further comprising receiving, from one or more transaction servers, local transaction data associated with merchant transactions in the locality.

7. The method according to claim 6, wherein performing the advertisement pricing process further includes performing the advertisement pricing process based additionally on the local transaction data.

8. The method according to claim 6, wherein performing the advertisement pricing process further includes determining a transaction frequency parameter for each period based on the local transaction data.

9. The method according to claim 8, wherein performing the advertisement pricing process further includes determining an affluence parameter based on the local transaction data, the affluence parameter associated with an average proportion of affluent consumers in the locality.

10. The method according to claim 9, wherein determining the affluence parameter comprises identifying affluent consumers based on the local transaction data and spending patterns of the affluent consumers.

11. The method according to claim 10, wherein determining the affluence parameter comprises determining the spending patterns of the affluent consumers based on global transaction data associated with global transactions performed by the affluent consumers.

12. The method according to claim 9, wherein performing the advertisement pricing process further includes determining the advertisement prices based additionally on the affluence parameters and/or transaction frequency parameters.

13. The method according to claim 6, wherein the advertisement prices are distinct by merchant categories determined from the local transaction data.

14. The method according to claim 6, further comprising identifying an advertisement category based on the local transaction data.

15. The method according to claim 1, wherein the advertisement pricing process is performed continuously to determine real-time advertisement prices.

16. The method according to claim 1, wherein the advertisement pricing process is iteratively performed at predefined intervals.

17. The method according to claim 1, further comprising receiving, from one or more service providers, service traffic data for aggregating with the traffic observation data to generate the vehicular traffic data.

18. The method according to claim 17, wherein the one or more service providers comprises one or more map service providers and/or one or more transportation service providers.

19. An electronic system for advertisement pricing, the system comprising a host server configured to:
identify a locality for displaying an advertisement;
receive traffic observation data from one or more traffic servers;
generate vehicular traffic data based on the traffic observation data, the vehicular traffic data indicative of vehicular traffic activity in the locality; and
perform an advertisement pricing process based on at least the vehicular traffic data to determine advertisement prices for displaying the advertisement in the locality.

20. A non-transitory computer-readable storage medium storing computer-readable instructions that, when executed by a host server, cause the host server to:
identify a locality for displaying an advertisement;
receive traffic observation data from one or more traffic servers;
generate vehicular traffic data based on the traffic observation data, the vehicular traffic data indicative of vehicular traffic activity in the locality; and
perform an advertisement pricing process based on at least the vehicular traffic data to determine advertisement prices for displaying the advertisement in the locality.
